(19) United States
(12) Patent Application Publication
(10) Pub. No.: US 2006/0044282 A1
(43) Pub. Date: Mar. 2, 2006

(54) User input apparatus, system, method and computer program for use with a screen having a translucent surface

(75) Inventors: Claudio Pinhanez, New York, NY (US); Gopal Pingali, Mohegan Lake, NY (US); Frederik C.M. Kjeldsen, Poughkeepsie, NY (US); Anthony Levas, Yorktown Heights, NY (US); Mark Edward Podlaseck, New Preston, CT (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/981,151

(22) Filed: Nov. 3, 2004

Related U.S. Application Data
(60) Provisional application No. 60/605,115, filed on Aug. 27, 2004.

(51) Int. Cl. G09G 5/00

(52) U.S. Cl. 345/173

(57) ABSTRACT

A user interface input apparatus and method allows the detection of when and where a user touches a surface of a translucent screen by the processing of imagery generated by a camera that views an opposite surface of the screen. An input device and system includes a translucent screen; an image capture device located for imaging a first side of the screen opposite a second side where user interaction occurs; and an image processor coupled to the output of the image capture device to determine at least one of where and when a person touches an area on the second side of the screen by a change in intensity of light emanating from the touched area relative to a surrounding area.

### CLAIM OF PRIORITY FROM COPENDING PROVISIONAL PATENT APPLICATION:

This patent application claims priority under 35 U.S.C. §119(e) from Provisional Patent Application No.: 60/605,115, filed 08/27/2004, the disclosure of which is incorporated by reference herein in its entirety.

### TECHNICAL FIELD

The teachings of this invention relate generally to user interface (UI) systems and devices and, more specifically, relate UI systems that employ a touch screen, and still more specifically to UI touch screen systems that use a translucent screen or panel.

### BACKGROUND

A desirable type of input panel or screen is a semi-transparent panel. For example, reference can be made to U.S. Pat. No. 6,414,672 B2, “Information Input Apparatus” by Rekimoto et al.

In general, traditional techniques that are used to create touch screens rely on overlaying an electricity-sensitive glass or glasses over the screen. However, this approach is not suitable for outdoor displays, such as store fronts, because of the possibility of vandalism and other factors, and furthermore is very expensive when used on a large screen.

Another approach provides one of the sides of the screen with light emitters, such as LEDs or similar devices, and the opposite side of the screen with light-sensitive elements. Hand interaction is detected by the occlusion of the light emitted by a particular LED. However, a disadvantage of this approach is the requirement to provide at least one of the LED or light-sensitive arrays outside of the glass in a store front, exposing them to vandalism.

Similarly, laser-scan and Doppler radar can be installed on the front side of the screen to determine user interaction, with similar disadvantages. Reference maybe had to, as examples, “Sensor Systems for Interactive Surfaces”, J. Paradiso, K. Hsiao, J. Strickon, J. Lifton, and A. Adler, IBM Systems Journal, Volume 39, Nos. 3 & 4, October 2000, pp. 892-914, and to “The Magic Carpet: Physical Sensing for Immersive Environments”, J. Paradiso, C. Abler, KY. Hsiao, M. Reynolds, in Proc. of the CHI '97 Conference on Human Factors in Computing Systems, Extended Abstracts, ACM Press, NY, pp. 277-278(1997).

Another technique for use with glass windows uses microphones and sound triangulation to determine when the user knocks on the glass. This method is described in “Passive Acoustic Sensing for Tracking Knocks Atop Large Interactive Displays”, Joseph A. Paradiso, Che King Leo, Nisha Checka, Kaijen Hsiao, in the 2002 Proceedings of the 2002 IEEE International Conference on Sensors, Volume 1, Orlando, Fla., Jun. 11-14, 2002, pp.521-527. Potential disadvantages of this approach include a need to put sensors directly in contact with the window and to run wires to them; and the need for a hard surface such as glass. In particular, this approach is not suitable for use with soft plastic rear-projected screens.

Cameras can be used to detect the user interaction with a translucent image. If the camera is positioned on the same side of the user then conventional computer vision gesture recognition techniques can be used to detect interaction. However, in this situation the issue of possible vandalism is a clear disadvantage, as well as the difficulty of mounting the camera in an appropriate position.

It would be preferable to position the camera on the rear side of the translucent surface so that the camera can be easily protected from vandalism. However, in such situations the user's image captured by the camera can be extremely blurred, thereby not allowing the use of traditional gesture recognition techniques. In the above-noted approach of Rekimoto et al. the camera and the projector are required to be fitted with IR filters, and infrared lighting is also required. A significant disadvantage of this method is that it cannot be used in situations where the translucent screen is exposed to significant amounts of ambient infrared light, such as when a store front window is exposed to direct sun light.

Reference may also be had to commonly-assigned U.S. Pat. No. 6,431,711 B1, “Multiple-Surface Display Projector with Interactive Input Capability”, by Claudio S. Pinhanez.

### SUMMARY OF THE PREFERRED EMBODIMENTS

The foregoing and other problems are overcome, and other advantages are realized, in accordance with the presently preferred embodiments of these teachings.

Embodiments of this invention provide an information input apparatus, method and computer program and program carrier. The apparatus includes a translucent screen; an image capture device located for imaging a first side of the screen opposite a second side where user interaction occurs; and an image processor coupled to the output of the image capture device to determine at least one of where and when a person touches an area on the second side of the screen by a change in intensity of light emanating from the touched area relative to a surrounding area.

A method to detect a user input in accordance with embodiments of this invention includes providing a system having a translucent screen having an image capture device located for imaging a first side of the screen opposite a second side where user interaction occurs. The method determines at least one of where and when a person touches an area on the second side of the screen by detecting a change in intensity of light emanating from the touched area relative to a surrounding area.

Further in accordance with embodiments of this invention there is provided a signal bearing medium that tangibly embodies a program of machine-readable instructions executable by a digital processing apparatus to perform operations to detect a user input. The operations include, in response to providing a system having a translucent screen having an image capture device located for imaging a first side of the screen opposite a second side where user interaction occurs: determining at least one of where and when a person touches an area on the second side of the screen by detecting a change in intensity of light emanating from the touched area relative to a surrounding area.

Still further in accordance with embodiments of this invention there is provided a touch screen system that includes a semi-transparent translucent screen; an image capture device located for imaging a first side of the screen opposite a second side whereon a user touches the screen; at least one light source disposed for illuminating the first side of the screen and providing an illumination differential between the first side and the second side; and an image processor coupled to the output of the image capture device to determine at least one of where and when the user touches an area on the second side of the screen by a change in intensity of light emanating from the touched area relative to a surrounding area. When incident light on the second side of the screen is brighter than incident light on the first side of the screen, an image of the point of contact with the screen is silhouetted and appears darker than the surrounding area, while when incident light on the first side of the screen is brighter than incident light on the second side of the screen, an image of the point of contact with the screen is highlighted and appears brighter than the surrounding area.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein;

FIG. 1 is a simplified system level block diagram of a touch-based input apparatus.

FIG. 2 shows results of an image difference process under different front/rear ambient light conditions.

FIG. 3 is a logic flow diagram of one cycle of a touch event detection image processing procedure.

### DETAILED DESCRIPTION OF THE PREFERRED EMBODIMENTS

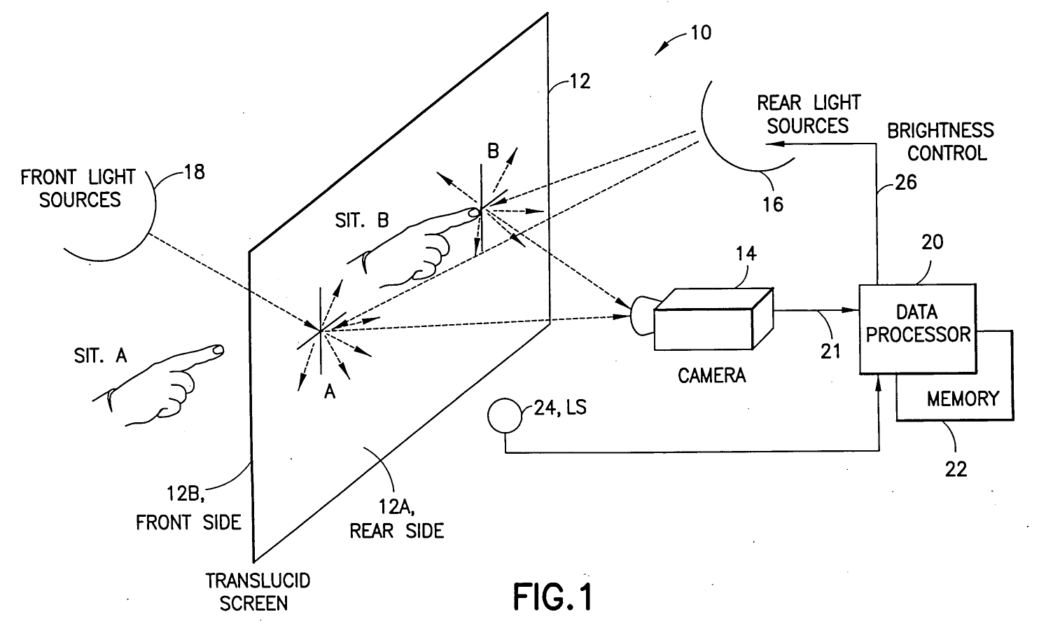

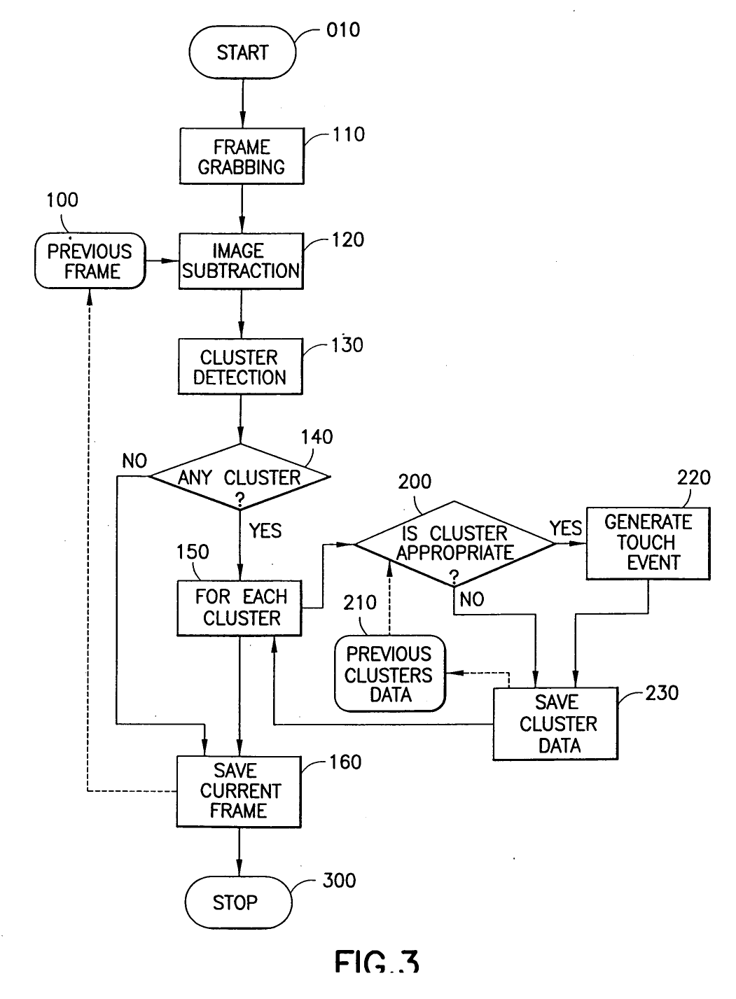

FIG. 1 shows the basic structure of a presently preferred embodiment of a user input system 10 under and two situations of input. The input system 10 includes a translucent screen 12, and an image capture device such as a video camera 14 that is positioned on a first side 12A, also referred to herein for convenience as a “rear” side, of the screen 12. A user is assumed to be positioned relative to a second side 12B of the screen 12, also referred to herein for convenience as the “front” side of the screen 12. There is at least one rear light source 16 and possibly at least one front light source 18 that are arranged for illuminating the rear side 12A of the screen 12 and front side 12B of the screen 12, respectively. It is assumed that there is a data processor 20 having a memory 22 arranged for receiving image data output from the camera 14. The data processor 20 could be a stand-alone PC, or a processor embedded in the camera 14, and it may be co-located with the camera 14 or located remotely therefrom. A link 21 between the camera 14 and the data processor 20 could be local wiring, or it could include a wired and/or a wireless connection, and at least part of the link 21 may be conveyed through a data communications network, such as the Internet. The memory 22 can store raw image data received from the camera 14, as well as processed image data, and may also store a computer program operable for directing the data processor 20 to execute a process that embodies the logic flow diagram shown in FIG. 3, and described below. The memory 22 can take any suitable form, and may comprise fixed and/or removable memory devices and medium, including semiconductor-based and rotating disk based memory medium.

The data processor 20 can digitize and store each frame captured by the camera 14 (if the camera 14 output is not a digital output). As will be described below, the data processor 20 also process the imagery by comparing two consecutive frames following the process shown in FIG. 3. Although there may be changes in the light environment on one or both sides of the screen 12, the change caused by user contact with the screen 12 is normally very strong and exhibits clearly defined boundaries. By using computer vision techniques such as thresholding, it becomes possible to detect the characteristic changes caused by the user touching the screen (either directly or through the use of a pointer or stylus or some other object).

The screen 12 could form, or could be a part of, as examples a wall, a floor, a window, or a surface of furniture. The screen 12 could be flat, curved and/or composed of multiple surfaces, adjacent to one another or separated form one another. The screen 12 could be composed of, by example, glass or a polymer. The detection of the user input may be associated with an object positioned on the front, rear, or in close proximity to the screen 12.

For the purposes of describing the presently preferred embodiments of this invention a translucent surface, such as at least one surface of the screen 12, transmits light, but causes sufficient scattering of the light rays so as to prevent a viewer from perceiving distinct images of objects seen through the surface, while yet enabling the viewer to distinguish the color and outline of objects seen through the surface. The screen 12 is herein assumed to be a “translucent screen” so long as it has at least one major surface that is translucent.

In accordance with embodiments of this invention, and in an input scenario or situation A, the user's hand is assumed to not touch the screen 12, specifically the front side 12B. In situation A, the dashed line A1 coming to the camera 14 corresponds to the main direction of the light coming from the image of the user's finger as seen by the camera 14 (point A). The dashed line arriving at the origin on the translucent screen 12 corresponds to the light coming from the front light source(s) 18. The light on the rear side 12A of the screen at point A in situation A is the sum of the light coming the front source(s) 18 which, due to the translucency effect in this case, is scattered uniformly in multiple directions on the rear side 12A of the screen 12. Light from the rear source(s) 16 is instead reflected by the screen 12. Therefore, in situation A, the image obtained by the camera 14 that corresponds to the position of the user's finger (point A) includes contributions from both the front light source(s) 18 (scattered in this case), and the rear light source(s) 16 (reflected).

In a second input scenario or situation B the user's hand (e.g., the tip of the user's index finger) is assumed to be touching the front surface 12B of the screen 12. In situation B, the line coming to the camera 14 from the user's finger touch-point (point B) corresponds to the main direction of the light coming from point B to the camera's aperture. Since the user's finger is in contact with the translucent screen 12, the light originating from the front light source(s) 18 is occluded by the tip of the finger and does not reach the front side surface 12B of the screen 12. Therefore, the light on the rear side 12A of the screen 12 at point B in situation B comes solely from the rear light source(s) 16, and corresponds to the sum of the light reflected from the rear surface 12A and the light reflected by the skin of the user's fingertip. Therefore, in situation B the image obtained by the camera 14 corresponding to the position of the user's finger (point B) is solely due to the reflection of the light coming from the rear light source(s) 16. It can be noticed that points in the area around point B, not covered by the user's finger, have similar characteristics of point A (i.e., the light reaching the camera 14 is light originating from both the front light source(s) 18 and the rear light source(s) 16).

The exact location of point A and/or point B on the screen 12 may be readily determined from a transformation from camera 14 coordinates to screen 12 coordinates.

As such, it can be appreciated than an aspect of this invention is a signal bearing medium that tangibly embodies a program of machine-readable instructions executable by a digital processing apparatus to perform operations to detect a user input. The operations include, in response to providing a system having a translucent screen having an image capture device located for imaging a first side of the screen opposite a second side where user interaction occurs: determining at least one of where and when a person touches an area on the second side of the screen by detecting a change in intensity of light emanating from the touched area relative to a surrounding area.

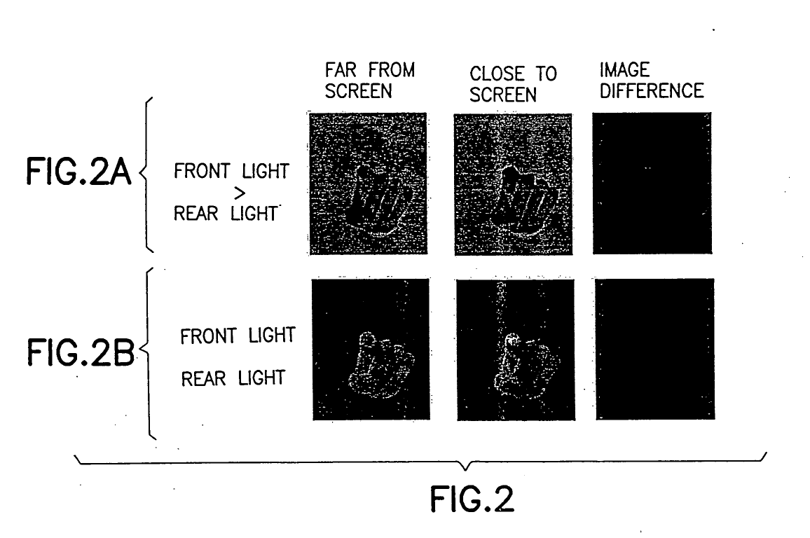

FIG. 2 shows examples of imagery obtained by the camera 14 when the user touches the screen 12 according to the difference between front and rear projection light source(s) 18 and 16, respectively. As shown in the top row of images (designated 2A), corresponding to a case where the front light source(s) 18 are brighter than the rear light source(s) 16, touching the screen 12 creates a dark area on the contact point. Since the front light source(s) 18 are brighter than the rear light source(s) 16, the touching situation obscures the user's finger skin on the point of contact from the influence of the front light source(s) 18. In this situation the user's finger reflects only the light coming from the rear light source(s) 16, which are less bright than the front light source(s) 18, thereby producing a silhouette effect for the fingertip. The second, lower row of images (designated 2B) illustrates the opposite effect, where the rear light source(s) 16 are brighter than the front light source(s) 18. In this situation, as the finger touches the screen 12, it reflects mostly the light arising from the rear light source(s) 16 and, since these are brighter than the front light source(s) 18, the image of the finger appears brighter from the camera 14. The last (right-most) column of FIG. 2 depicts the absolute difference between the two previous images in the same row. As can be readily seen, the largest absolute difference between the two previous images in each row occurs exactly at the point on the front side surface 12B that is touched by the user.

FIG. 3 shows a logical flow diagram that is descriptive of one cycle of the method to detect those situations where a user, or multiple users, touch the screen 12 either sequentially or simultaneously. It is assumed that the logical flow diagram is representative of program code executed by the data processor 20 of FIG. 1. The procedure starts (010) by grabbing one digitized frame (110) of the video stream produced by the camera 14. If the video output of the camera is in analog form, then the analog video signal is preferably digitized at this point. In the next step, the grabbed frame is subtracted pixel-by-pixel (120) from a frame captured in a previous cycle (100), producing a difference image. To simplify the following computation, a non-limiting embodiment of the invention uses the absolute value of the difference on each pixel. The difference image is scanned and pixels with high values are detected and clustered together (130) in data structures stored in the computer memory 22. If no such cluster is found (140), the procedure jumps to termination, saving the current frame (160) to be used in the next cycle as the previous frame (100), and completes the cycle (300). If at least one cluster of high difference value are found (140), the procedure examines each detected cluster separately (150). For each cluster, the procedure determines whether generating a touch event is appropriate (200) considering either or both the current cluster data and the previous clusters data (210). This evaluation can include, but is certainly not limited to, one or more of a determination of the size of a cluster of high difference value pixels and a determination of the shape of a cluster of high difference value pixels. If the cluster is found to be appropriate to generate an event, the procedure generates and dispatches a detected touch event (220) to the client application or system. After generating the touch event (220), or if a cluster is deemed not appropriate to generate a touch event (the No path from (200)), the procedure saves the cluster data (230) for use in future cycles (210). After all clusters are examined (150), the procedure saves the current frame (160) to be used in the next cycle and completes the current cycle (300).

A non-limiting aspect of this invention assumes that the amount of light from the front light source(s) 18 that passes through the screen 12 is different than the amount of light reflected by the skin from the rear light source(s) 16. Otherwise, the changes are not detectable by the computer vision system. However, situations where both light levels are similar occur rarely, and may be compensated for by increasing the amount of front or rear light. En particular, it has been found that it is preferable to have the front light source 18 brighter than the rear light source 16.

As was noted in the discussion of FIG. 2, if the amount of front generated light passing through the rear side surface 12A of the screen 12 is greater than the rear light being reflected from the rear side surface, the user's point of contact with the front side surface 12B is silhouetted, creating a dark spot (row 2A). By differencing consecutive frames of the image stream (e.g., frames generated at a rate of 30 per second), the data processor 20 is able to detect the time when the user touches the screen 12, and also the duration of the contact. Notice that at the moment of contact, because of the light difference, there is a remarkably discontinuous change in the image. In the opposite situation, that is, when the rear light reflected by the skin of the user's finger is brighter than the light passing through the surface 12A from the front light source(s) 18 (row 2B), one can again observe a clear change in the image at the moment of contact.

In the procedure described in FIG. 3 a relatively basic computer vision method can be used, such as one known as image differencing. One non-limiting advantage of using image differencing is that the procedure is tolerant of the movement of the user relative to the front side surface 12B of the screen 12, and to gradual changes in ambient lighting. However, in another embodiment, where there is little change in the rear image of the screen 12 except when the user touches the screen, a methodology based on background subtraction could be used. In this case an image of the surface is taken in a situation where it is known that there is no user interaction (e.g., during a calibration phase). This reference image is then compared to each frame that is digitized by the camera 14. When the user touches the surface 12B, a strong light change occurs at the point of contact (as described above). In this case it is possible to track the movement of the user's hand in contact with the screen 12, as well as to detect for how long the user touches the screen 12. A similar approach may use a statistical technique to slowly update the reference image to accommodate changes in the environment and in the lighting conditions.

A further embodiment of this invention combines the translucent surface of the screen 12 with a projection system, such as a slide projector, a video projector, or lighting fixtures, transforming the surface to an interactive graphics display. In such an embodiment the foregoing operations are still effective, since if the front light source 18 is considerably brighter than the projected image, the image taken from the camera 14 of the rear side surface 12A is substantially unaffected by the projection. Therefore, the point of contact of the user's hand still generates a strong silhouette, detectable by the data processor 20 vision system. However, if the rear projected-image is significantly brighter than the front light going through the surface 12A, there may be situations where a change in the projected image could be mistakenly recognized as a user's contact with the surface 12B. There are, however, solutions for this potential problem: a) the areas for interaction can be freed from projected imagery, and the computer vision system instructed to look for interaction only on those areas; b) the shape of the difference pattern can be analyzed by computer vision and pattern recognition methods (including statistical and learning based methods) and only those shapes that resemble a particular kind of user interaction (such as touching with a finger) are accepted. This latter solution can be used also to improve the detection performance in the general case described above with regard to FIGS. 2 and 3.

In another embodiment, multiple users can use the system 10 at the same time, or interact with both hands. As long as the points of contact are reasonably separated, the procedure described in FIG. 3 detects multiple areas of contact with the front side surface 12B of the screen 12.

In another embodiment of this invention the data processor 20 is provided with at least one light sensor (LS) 24 to monitor the light source levels at the front side 12B and/or the rear side 12A of the screen 12 to determine an amount of the difference in the illumination between the two sides. This embodiment may further be enhanced by permitting the data processor 20 to control the intensity of one or both of the rear and front light source(s) 16 and 18, so that the difference in brightness can be controlled. This light source control is indicated in FIG. 1 by the line 26 from the data processor 20 to the rear light source(s) 16.

In general, the LS 24 may be used to determine a difference in ambient light levels to ensure that the system 10 is usable, and/or as in input to the image processing algorithm as a scale factor or some other parameter. Preferably the LS 24 is coupled to the data processor 20, or some other networked device, so that the image processing algorithm(s) can obtain the ambient light level(s) to automatically determine whether there is enough ambient light difference for the system 10 to operable with some expected level of performance. Preferably there may be an ability to increase or decrease the light level from the front and/or the rear sides of the translucent screen 12. In this case the data processor 20 can be provided with the brightness control 26. Preferably the LS 24 and the brightness control 26 can be used together in such a way that the data processor 20 is able to change the brightness level of the front or the rear sides of the screen 12, or both.

In another embodiment a system with multiple screens 12 and a single camera 14 or projector/camera system can be used, assuming that the system is able to direct the camera 14 and/or the projector to attend each of the screens 12. In this case the multiple screens 12 can be illuminated by a single light source or by multiple light sources, either sequentially or simultaneously.

Based on the foregoing description it can be appreciated that in one aspect thereof this invention provides input apparatus and methods for a screen 12 having a translucent surface that uses the camera 14 and the data processor 20 to process an image stream from the camera 14. The camera 14 is positioned on the opposite side of screen 12 from the user or users of the system 10. Because the surface is translucent, the image of the users and their hands can be severely blurred. However, when the user touches the surface 12B, the image of the point of contact on the surface becomes either significantly brighter or significantly darker than the rest of the surface, according to the difference between the incident light from each side of the surface. If the incident light on the user's side is brighter than on the camera side, the point of contact is silhouetted, and therefore, significantly darker. If the incident light on the user's side is darker than on the camera side, the user's skin in contact with the surface reflects the light coming from the camera side, and therefore the point of contact is significantly brighter than the background. To detect when the user touches the surface, an image differencing technique maybe employed. In this non-limiting case consecutive frames are subtracted from one another such that when the user touches the surface, a significant difference in brightness at the point of contact can be readily detected by a thresholding mechanism, or by motion detection algorithms. The apparatus and method accommodates multiple and simultaneous interaction on different areas of the screen 12, as long as they are reasonably apart from each other.

Note that in at least one embodiment of the invention only the rear light source(s) 16 may be provided, and the front light source(s) 18 maybe provided solely by environmental lighting (e.g., sun light during the day and street lighting at night). In this case it may be desirable to provide the automatic control 26 over the brightness of the rear light source(s) to accommodate the changing levels of illumination at the front side 12B of the screen 12.

Note further that in at least one embodiment of the invention the user input detected by the system 10 may be used to control imagery being projected on the translucent screen 12.

Note further that in at least one embodiment of the invention the user input detected by the system 10 can be used by the data processor 20 to recognize specific body parts, such as fingers or hands, or prosthetics.

The apparatus and methods in accordance with embodiments of this invention have a number of advantages over conventional techniques. For example, embodiments in accordance with this invention use images taken by the camera 14 positioned on the opposite side of the screen 12 in relation to the user. Therefore, this invention can be used in store fronts and similar situations where it is desired to protect the system hardware, such as the camera 14, from environmental influences. The apparatus and methods in accordance with embodiments of this invention also allow for multiple and simultaneous inputs from one or more users, unlike the conventional methods and systems based on sound, laser, Doppler radar and LED arrays.

Further, the apparatus and methods in accordance with embodiments of this invention do not require IR filters or special lighting. Thus, a less complex and less expensive user input system is enabled, and the system can be used those situations where the screen 12 is exposed to significant amounts of infrared light, such as when a store front is exposed to direct sun light.

What is claimed is:

1. An information input apparatus comprising:
a translucent screen;
an image capture device located for imaging a first side of the screen opposite a second side where user interaction occurs; and
an image processor coupled to the output of the image capture device to determine at least one of where and when a person touches an area on the second side of the screen by a change in intensity of light emanating from the touched area relative to a surrounding area.

2. An information input apparatus as in claim 1, where the image processor uses an image differencing technique.

3. An information input apparatus as in claim 1, where the image processor uses a background subtraction technique.

4. An information input apparatus as in claim 1, further comprising at least one light source located for illuminating the first side of the screen.

5. An information input apparatus as in claim 4, further comprising at least one light source located for illuminating the second side of the screen.

6. An information input apparatus as in claim 1, where when incident light on the second side of the screen is brighter than incident light on the first side of the screen, an image of the point of contact with the screen is silhouetted and appears darker than the surrounding area, while when incident light on the first side of the screen is brighter than incident light on the second side of the screen, an image of the point of contact with the screen is highlighted and appears brighter than the surrounding area.

7. An information input apparatus as in claim 6, where said image processor detects a location of the point of contact by comparing a first image of the first side of the screen with a second image of the first side of the screen.

8. An information input apparatus as in claim 6, where said image processor detects a time of the contact by comparing a first image of the first side of the screen with a second image of the first side of the screen.

9. An information input apparatus as in claim 1, where there are a plurality of screens serviced by a single camera one of sequentially or simultaneously.

10. An information input apparatus as in claim 1, where the screen is arranged to display projected imagery generated by an imaging device.

11. A method to detect a user input, comprising providing a system having a translucent screen having an image capture device located for imaging a first side of the screen opposite a second side where user interaction occurs; the method determining at least one of where and when a person touches an area on the second side of the screen by detecting a change in intensity of light emanating from the touched area relative to a surrounding area.

12. A method as in claim 11, where detecting uses an image differencing technique.

13. A method as in claim 11, where detecting uses a background subtraction technique.

14. A method as in claim 11, further comprising providing at least one light source located for illuminating the first side of the screen.

15. A method as in claim 14, further comprising providing at least one additional light source located for illuminating the second side of the screen.

16. A method as in claim 11, where when incident light on the second side of the screen is brighter than incident light on the first side of the screen, detecting detects that an image of the point of contact with the screen is silhouetted and appears darker than the surrounding area, while when incident light on the first side of the screen is brighter than incident light on the second side of the screen, detecting detects that an image of the point of contact with the screen is highlighted and appears brighter than the surrounding area.

17. A method as in claim 16, where detecting detects a location of the point of contact by comparing a first image of the first side of the screen with a second image of the first side of the screen.

18. A method as in claim 16, where detecting detects a time of the contact by comparing a first image of the first side of the screen with a second image of the first side of the screen.

19. A method as in claim 11, where there are a plurality of screens provided and serviced by a single camera sequentially or simultaneously.

20. A method as in claim 11, further comprising displaying projected imagery generated by an imaging device on the screen.

21. A method as in claim 11, further comprising detecting a difference between incident light on the second side of the screen and incident light on the first side of the screen, and using the detected difference to control the brightness of at least one light source.

22. A signal bearing medium tangibly embodying a program of machine-readable instructions executable by a digital processing apparatus to perform operations to detect a user input, the operations comprising, in response to providing a system having a translucent screen having an image capture device located for imaging a first side of the screen opposite a second side where user interaction occurs: determining at least one of where and when a person touches an area on the second side of the screen by detecting a change in intensity of light emanating from the touched area relative to a surrounding area.

23. A signal bearing medium as in claim 22, where detecting uses an image differencing technique.

24. A signal bearing medium as in claim 22, where detecting uses a background subtraction technique.

25. A signal bearing medium as in claim 22, where providing further provides at least one light source located for illuminating the first side of the screen.

26. A signal bearing medium as in claim 25, where providing further provides at least one additional light source located for illuminating the second side of the screen.

27. A signal bearing medium as in claim 22, where when incident light on the second side of the screen is brighter than incident light on the first side of the screen, detecting detects that an image of the point of contact with the screen is silhouetted and appears darker than the surrounding area, while when incident light on the first side of the screen is brighter than incident light on the second side of the screen, detecting detects that an image of the point of contact with the screen is highlighted and appears brighter than the surrounding area.

28. A signal bearing medium as in claim 27, where detecting detects a location of the point of contact by comparing a first image of the first side of the screen with a second image of the first side of the screen.

29. A signal bearing medium as in claim 27, where detecting detects a time of the contact by comparing a first image of the first side of the screen with a second image of the first side of the screen.

30. A signal bearing medium as in claim 22, where there are a plurality of screens provided and serviced by a single camera sequentially or simultaneously.

31. A signal bearing medium as in claim 22, further comprising displaying projected imagery generated by an imaging device on the screen.

32. A signal bearing medium as in claim 22, further comprising detecting a difference between incident light on the second side of the screen and incident light on the first side of the screen, and using the detected difference to control the brightness of at least one light source.

33. A touch screen system comprising:
a translucent screen;
an image capture device located for imaging a first side of the screen opposite a second side whereon a user touches the screen;
at least one light source disposed for illuminating the first side of the screen and providing an illumination differential between the first side and the second side; and
an image processor coupled to the output of the image capture device to determine at least one of where and when the user touches an area on the second side of the screen by a change in intensity of light emanating from the touched area relative to a surrounding area, where when incident light on the second side of the screen is brighter than incident light on the first side of the screen, an image of the point of contact with the screen is silhouetted and appears darker than the surrounding area, while when incident light on the first side of the screen is brighter than incident light on the second side of the screen, an image of the point of contact with the screen is highlighted and appears brighter than the surrounding area.

34. A touch screen system as in claim 33, where the screen comprises at least a part of a window, and where the second side is an out-of-doors side of the window.

35. A touch screen system as in claim 34, further comprising light source control for adjusting the brightness level of the at least one source of illumination as a function of an amount of illumination on the second side of the screen.
